(19) United States
(12) Patent Application Publication
(10) Pub. No.: US 2016/0260170 A1
(43) Pub. Date: Sep. 8, 2016

(54) System for Active Gold Redemption

(71) Applicant: Ronaldo Batista DOS SANTOS, Santo André (BR)

(72) Inventor: Ronaldo Batista DOS SANTOS, Santo André (BR)

(21) Appl. No.: 14/764,412

(22) PCT Filed: Apr. 23, 2014
(86) PCT No.: PCT/BR2014/000130

§ 371 Date: Jul. 29, 2015

(30) Foreign Application Priority Data
Mar. 21, 2014 (BR) 1020140068163

(51) Int. Cl. G06Q 40/04; G07F 19/00

(52) U.S. Cl. CPC G06Q 40/04; G07F 19/203

(57) ABSTRACT

SYSTEM FOR ACTIVE GOLD REDEMPTION, through which a central operations (1) accredited by the SNF and the Central Bank, with Product Mineral Financial Certificate—Gold Ore, CPMF (2), develop a system whereby the investor (3) duly registered gold can, using a specific magnetic Cato (4), the access terminal ATMs (5) the purchase and sale of gold also members of the system. Through the system, the investor (3), possession of specific magnetic card (4) can withdraw from ATM (5) accessed, active gold (6) in the form of gold bars, gold coins, jewelry, and collections, as well as prints in gold, properly monetized, or receive its value in cash credited to your credit card. If the value of the certificate redemption option in cash, with the same card the certificate holder may also withdraw your physical gold (bars) at the partner agencies.

Refers to the application for patent for a system whereby the inverted after his accession, being in possession of evidence (CPMF) authorized by the Central Bank and issued by the Mint, will be able to redeem or monetize its capital through the withdrawal of gold bars in specific ATMs buying and selling gold. To remove the user will use a prepaid credit card provided by the system in question, reason for this patent application.

### PRIOR ART

As you know, gold—in any state of purity, crude or refined, is a financial asset or part exchange instrument for investors seeking liquidity and safety of this ancient form of application. Gold can be then for the financial market or the operation of exchange of the country policy operations with the intervention of institutions of the National Financial System (SFN), in the manner and under conditions approved by the Central Bank of Brazil (BCB).

The financial gold assets can be traded under the following conditions:

Scriptural;

Physical delivery.

Therefore, the gold involved in processing, refining, transportation, storage or custody, since formalized can be traded in financial transactions on the trading floors of stock exchanges, commodities, futures or similar or on the counter with the intervention of a financial institution authorized (SNF-Central Bank).

Through a certificate—CPMIN-F, Mineral Product Certificate Financial, the investor acquires extrajudicial guarantee (bank, lessor, etc.), judicial (Executions you stand, Debts in general, etc.), giving in payment negotiations in general and other tasks, so you can buy warranty certificates of another and wanting remove them from the custodian and may monetize it (active) through a DTVM.

Thus, as gold is accepted by financial institutions for use in the financial market, the monetization of these assets may vary according to the price of the stock exchange, its face value. In addition to the monetization, the certificates are also accepted by financial institutions as payment of debts before those institutions. In addition, the certificates are accepted for payment of tax debts, as well as taxes becoming due, being a viable, legal and practice of payment of taxes.

### OBJECTIVE OF THE INVENTION

The system in question will facilitate the monetization processing of the gold assets, enabling the investor, after its accession, regulated by a certificate issued by the SNF and the Central Bank, purchase a magnetic card by which, on machines specify ATM, connected to the system, can withdraw gold bars, properly monetized, or receive the dividend in cash credited to your credit card. If the value of the certificate redemption option in cash, with the same card the certificate holder may also withdraw your physical gold (bars) at the partner agencies.

Superficially explained, the system shall be further detailed by the accompanying drawings, which are seen by:

FIG. 1—Schematic view of the system in the form of a central operations, for which a certificate is issued—CPMIN F (Certificate of Product Mineral Financial—Gold Ore). The system also sends the joined investor, a magnetic card and also produces the specific ATM for the purchase and sale of gold;

FIG. 2—view in perspective of system operation. The figure is shown that the specific ATM cash buying and selling gold is accessed by the investor card, which removes the terminal gold bars, gold coins, jewelry, and collections, as well as prints in gold.

In accordance with the accompanying drawings, the “SYSTEM FOR GOLD PURCHASE ASSETS IN ATM'S” object of this application for patent, is constituted from a central operations (1), duly accredited with the SNF and the Central Bank, for the marketing of gold assets through a certificate of Product Mineral Financial—Gold Ore, CPMF (2), which receives investors adherence to (3) and produces a specific magnetic card (4), for use in ATMs's (5) also specific buying and selling of another, working together with recognized banks such as Bradesco, Itau, BNDES, investment funds and others.

Thus, the system comprising the operations center (1) emits a magnetic card (4) to the investor (3), whereby the gold can be removed from the ATM terminal (5) in active form gold (6) as gold bars, gold coins, jewelry, and collections, as well as prints in gold, or receive the dividend in cash credited to your credit card. If the value of the certificate redemption option in cash, with the same card the certificate holder may also withdraw your physical gold (bars) at the partner agencies.

1) A SYSTEM FOR ACTIVE GOLD REDEMPTION, made from a central operations (1) duly licensed for commercialization of gold, with the SNF and the Central Bank, through Financial Mineral Product Certificate certificate—Gold Ore, CPMF (2) characterized by central operations (1) to produce ATMs boxes (5) the purchase and sale of gold working with participating banks of the system and sending to the investor (3) registered, a magnetic card (4) specific for use in these ATMs (5).

2) THE SYSTEM FOR ACTIVE GOLD REDEMPTION, according to claim 1, characterized by the investor (3) duly registered by the system operations center (1), possession of specific magnetic card (4) issued by the system, the access terminal ATM (5) and remove the active gold (6) properly monetized in the form of gold bars, gold coins, jewelry, and collections, as well as prints in gold, or receive the dividend in cash credited to your credit card. If the value of the certificate redemption option in cash, with the same card the certificate holder may also withdraw your physical gold (bars) at the partner agencies.
